(19) United States
(12) Patent Application Publication
(10) Pub. No.: US 2025/0174671 A1
(43) Pub. Date: May 29, 2025

(54) LITHIUM SECONDARY BATTERY

(71) Applicants: Nissan Motor Co., Ltd., Kanagawa (JP); RENAULT S.A.S., Boulogne-Billancourt (FR)

(72) Inventors: Tomohisa Matsuno, Kanagawa (JP); Harumi Takada, Kanagawa (JP); Kazuyuki Sakamoto, Kanagawa (JP)

(73) Assignees: Nissan Motor Co., Ltd., Kanagawa (JP); RENAULT S.A.S., Boulogne-Billancourt (FR)

(21) Appl. No.: 19/028,649

(22) Filed: Jan. 17, 2025

Related U.S. Application Data
(63) Continuation of application No. PCT/IB2022/000416, filed on Jul. 22, 2022.

(51) Int. Cl. H01M 4/62; H01M 4/38; H01M 10/052; H01M 10/0585

(52) U.S. Cl. CPC H01M 4/628; H01M 4/382; H01M 10/052; H01M 10/0585

(57) ABSTRACT

A lithium secondary battery using a sulfur-containing component is provided. The lithium secondary battery is capable of suppressing a short circuit and achieving excellent battery performance in a lithium deposition type lithium secondary battery including a negative electrode current collector containing copper. The lithium secondary battery includes a positive electrode, a negative electrode including a negative electrode current collector containing copper, and a lithium metal anode when the lithium secondary battery is in at least partially charged state, a solid electrolyte layer interposed between the positive electrode and the negative electrode, an ion-conductive reaction suppression layer on a surface of the solid electrolyte layer and positioned in between the solid electrolyte layer and the negative electrode current collector, and a layer containing copper sulfide having a thickness of 100 nm or less interposed between the negative electrode current collector and the ion-conductive reaction suppression layer or the lithium metal anode.

### TECHNICAL FIELD

One or more embodiments of the present invention relate to a lithium secondary battery.

### BACKGROUND

In recent years, in the automobile industry, expectations have been focused on reduction of a carbon dioxide emission amount by introduction of an electric vehicle (EV) and a hybrid electric vehicle (HEV), and development of lithium secondary batteries such as a secondary battery for driving a motor, which is a key to practical application of these, has been actively conducted. In particular, research and development on all-solid-state lithium secondary batteries using a solid electrolyte as an electrolyte have been actively conducted. The solid electrolyte is a material mainly composed of an ion conductor capable of ion conduction in a solid. For this reason, in the all-solid-state lithium secondary battery, various problems caused by the combustible organic electrolyte solution as in the liquid-type lithium ion secondary battery do not occur in principle. In general, when a positive electrode material having a high potential and a large capacity and a negative electrode material having a large capacity are used, the power density and the energy density of the battery can be significantly improved. An all-solid-state lithium secondary battery using a sulfur simple substance (S) or a sulfide-based material as a positive electrode active material is a promising candidate. Furthermore, since the sulfide solid electrolyte has high lithium-ion conductivity, it is possible to increase the output of the battery by using the sulfide solid electrolyte.

Various metals have been conventionally used as current collectors of lithium secondary batteries. However, in a lithium secondary battery containing a sulfur-containing component such as a sulfide solid electrolyte, when copper or nickel is used as a current collector, the lithium secondary battery reacts with sulfur to deteriorate battery performance.

In view of the above, for example, JP 2012-256436 A discloses a step of charging a battery under a condition that a negative electrode current collector is not sulfurized after each constituent layer of an all-solid-state lithium secondary battery is laminated and bonded. Consequently, sulfurization of the negative electrode current collector is prevented, deterioration of battery performance is suppressed, and storage stability of the battery may be improved.

### SUMMARY

As one type of all-solid-state lithium secondary batteries using lithium metal as a negative electrode active material, a so-called lithium deposition type battery in which lithium metal is deposited on a negative electrode current collector in a charging process is known. In the charging process of such a lithium deposition type all-solid-state lithium secondary battery, lithium metal is deposited between the solid electrolyte layer and the negative electrode current collector. A fine particle layer containing particles of amorphous carbon or the like may be disposed between the negative electrode current collector and the solid electrolyte layer constituting the power generating element of such an all-solid-state lithium secondary battery. Consequently, when lithium metal is deposited between the above-described fine particle layer and the negative electrode current collector during charging, the fine particle layer serves as a protective layer for the lithium metal layer, and growth of dendrite from the lithium metal layer is suppressed, so that a short circuit of the all-solid-state lithium secondary battery, a decrease in capacity due to the short circuit, and the like are prevented.

Here, the inventors of the present invention have attempted to apply the technique described in JP 2012-256436 A to a lithium deposition type all-solid-state lithium secondary battery including the above-described fine particle layer, using a sulfur-containing component and a negative electrode current collector containing copper. However, in such a configuration, it has been found that lithium metal may be deposited at an interface between the fine particle layer and the solid electrolyte layer when the all-solid-state lithium secondary battery is charged. In such a case, the lithium metal may grow dendrite to be in contact with the solid electrolyte layer, which may lead to a short circuit of the battery.

Therefore, a solution capable of suppressing a short circuit and achieving excellent battery performance in a lithium deposition type lithium secondary battery using a sulfur-containing component and including a negative electrode current collector containing copper is provided.

The inventors of the present invention have conducted intensive studies in order to address the above. As a result, the inventors of the present invention have found that, in a lithium deposition type lithium secondary battery using a sulfur-containing component and including a negative electrode current collector containing copper, the above may be addressed by providing an ion-conductive reaction suppression layer having lithium-ion conductivity and suppressing a reaction between lithium metal and a solid electrolyte on a surface of a solid electrolyte layer on the negative electrode current collector side, and disposing a layer containing copper sulfide having a thickness of 100 nm or less between the ion-conductive reaction suppression layer and the negative electrode current collector, and have completed one or more embodiments of the present invention.

That is, one or more aspects of the present invention are a lithium secondary battery including a power generating element including: a positive electrode in which a positive electrode active material layer containing a positive electrode active material capable of occluding and releasing lithium ions is disposed on a surface of a positive electrode current collector; a negative electrode including a negative electrode current collector containing copper and in which lithium metal is deposited on the negative electrode current collector during charging; and a solid electrolyte layer that is interposed between the positive electrode and the negative electrode and contains a solid electrolyte, in which the positive electrode active material contains a sulfur element, or the solid electrolyte layer contains a sulfide solid electrolyte, and an ion-conductive reaction suppression layer having lithium-ion conductivity and suppressing a reaction between the lithium metal and the solid electrolyte is provided on a surface of the solid electrolyte layer on a side of the negative electrode current collector, and a layer containing copper sulfide having a thickness of 100 nm or less exists between the ion-conductive reaction suppression layer and the negative electrode current collector.

### BRIEF DESCRIPTION OF THE DRAWINGS

FIG. 1 is a cross-sectional view schematically illustrating the overall structure of a laminate all-solid-state lithium secondary battery as one or more embodiments of the present invention during complete charge.

FIG. 2(a) is an enlarged cross-sectional view of a single battery layer 19 during complete discharge of a laminate type secondary battery according to one or more embodiments of the present invention.

FIG. 2(b) is an enlarged cross-sectional view of a single battery layer 19 during complete charge of a laminate type secondary battery according to one or more embodiments of the present invention.

FIG. 2(c) is a view schematically illustrating a measurement position of a thickness of a layer containing copper sulfide in a plane direction of a negative electrode current collector.

FIG. 3 is a perspective view of a laminate type secondary battery according to one or more embodiments of the present invention.

### DETAILED DESCRIPTION

One or more aspects of the present invention are a lithium secondary battery including a power generating element including: a positive electrode in which a positive electrode active material layer containing a positive electrode active material capable of occluding and releasing lithium ions is disposed on a surface of a positive electrode current collector; a negative electrode including a negative electrode current collector containing copper and in which lithium metal is deposited on the negative electrode current collector during charging; and a solid electrolyte layer that is interposed between the positive electrode and the negative electrode and contains a solid electrolyte, in which the positive electrode active material contains a sulfur element, or the solid electrolyte layer contains a sulfide solid electrolyte, an ion-conductive reaction suppression layer having lithium-ion conductivity and suppressing a reaction between the lithium metal and the solid electrolyte is provided on a surface of the solid electrolyte layer on a side of the negative electrode current collector, and a layer containing copper sulfide having a thickness of 100 nm or less exists between the ion-conductive reaction suppression layer and the negative electrode current collector. According to the present aspect, it is possible to suppress a short circuit and achieve excellent battery performance in a lithium deposition type lithium secondary battery using a sulfur-containing component and including a negative electrode current collector containing copper.

Hereinafter, the present aspect will be described with reference to the drawings, but the technical scope of the present invention should be determined on the basis of the description of the claims, and is not limited only to the following aspects. Note that dimensional ratios in the drawings are exaggerated for convenience of description, and may be different from actual ratios.

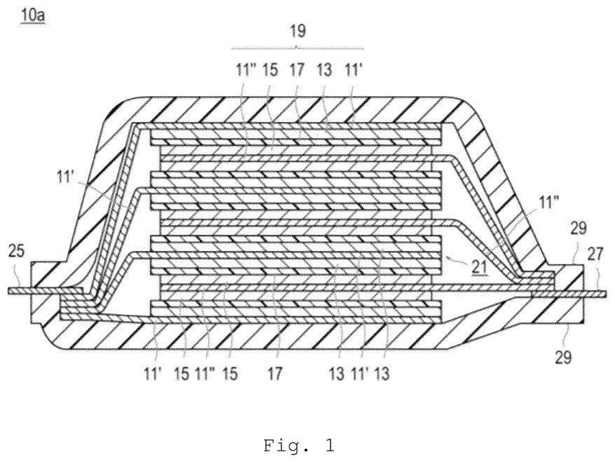

FIG. 1 is a cross-sectional view schematically illustrating the overall structure of a laminated (internal parallel connection type) all-solid-state lithium secondary battery (hereinafter, also simply referred to as “laminate type secondary battery”) as one or more embodiments of the present invention during complete charge. A laminate type secondary battery 10a illustrated in FIG. 1 has a structure in which a power generating element 21 of a substantially rectangular shape with a charge-discharge reaction actually proceeding therein is sealed inside a laminate film 29 which is a battery outer casing body. FIG. 1 illustrates a cross section of the laminate type secondary battery during charging, and thus the negative electrode active material layer 13 made of lithium metal exists between the negative electrode current collector 11′ and the solid electrolyte layer 17. A confining pressure is applied to the laminate type secondary battery 10a in the lamination direction of the power generating elements 21 by the pressurizing member (not illustrated). Therefore, the volume of the power generating element 21 is kept constant.

As illustrated in FIG. 1, the power generating element 21 of the laminate type secondary battery 10a of the present aspect has a configuration in which a negative electrode in which the negative electrode active material layer 13 is disposed on both surfaces of the negative electrode current collector 11′, a solid electrolyte layer 17, and a positive electrode in which a positive electrode active material layer 15 is disposed on both surfaces of a positive electrode current collector 11″ are laminated. Specifically, the negative electrode, the solid electrolyte layer, and the positive electrode are laminated in this order such that the one negative electrode active material layer 13 and the positive electrode active material layer 15 adjacent thereto face each other with the solid electrolyte layer 17 interposed therebetween. Consequently, the adjacent negative electrode, the solid electrolyte layer, and the positive electrode constitute one single battery layer 19. Therefore, it can be said that the laminate type secondary battery 10a illustrated in FIG. 1 has a configuration in which a plurality of the single battery layers 19 are laminated to be electrically connected in parallel.

A structure is provided in which a negative electrode current collecting plate 25 and a positive electrode current collecting plate 27, which are electrically connected to the respective electrodes (the negative electrode and the positive electrode), are respectively attached to the negative electrode current collector 11′ and the positive electrode current collector 11″, and the negative electrode current collecting plate 25 and the positive electrode current collecting plate 27 are sandwiched between end parts of the laminate film 29 and led out of the laminate film 29. The negative electrode current collecting plate 25 and the positive electrode current collecting plate 27 may be attached to the negative electrode current collector 11′ and the positive electrode current collector 11″ of each electrode by ultrasonic welding, resistance welding, or the like via a negative electrode terminal lead and a positive electrode terminal lead (not illustrated), respectively, as necessary.

In the above-described description, an embodiment of the lithium secondary battery according to one or more aspects of the present invention has been described by taking the laminate type (internal parallel connection type) all-solid-state lithium secondary battery as an example. However, the type of lithium secondary battery to which one or more embodiments of the present invention can be applied is not particularly limited, and one or more embodiments of the present invention can also be applied to bipolar lithium secondary batteries.

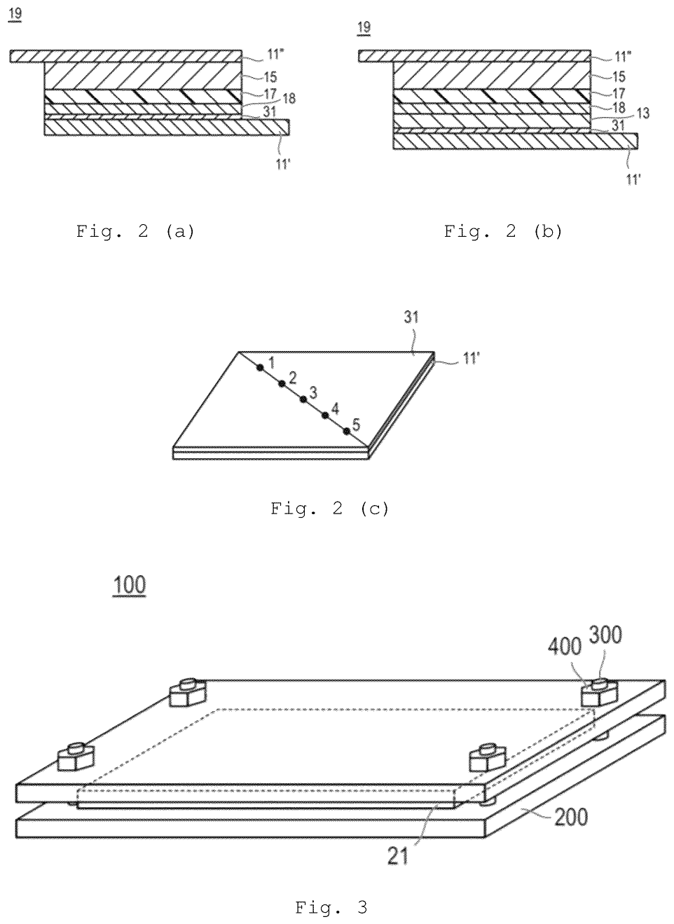

FIG. 2(a) is an enlarged cross-sectional view of the single battery layer 19 during complete discharge (or before initial charge) of a laminate type secondary battery according to one or more embodiments of the present invention. FIG. 2(b) is an enlarged cross-sectional view of the single battery layer 19 during complete charge of the laminate type secondary battery according to one or more embodiments illustrated in FIG. 1. As illustrated in FIG. 2(a), the single battery layer 19 constituting the laminate type secondary battery 10a according to the present embodiment has a positive electrode including the positive electrode current collector 11″ and the positive electrode active material layer 15 disposed on the surface thereof. In addition, the solid electrolyte layer 17 containing a solid electrolyte is disposed on a surface of the positive electrode active material layer 15 on a side opposite to the positive electrode current collector 11″. Here, the positive electrode active material layer 15 contains a positive electrode active material containing a sulfur element, or the solid electrolyte layer 17 contains a sulfide solid electrolyte.

Then, during complete charge illustrated in FIG. 2(b), on the solid electrolyte layer 17 side of the negative electrode current collector 11′ containing copper, the negative electrode active material layer 13 (lithium metal) is disposed at a position facing the positive electrode active material layer 15.

In one or more embodiments illustrated in FIGS. 2(a) and 2(b), the ion-conductive reaction suppression layer 18 is provided in a region including the entire region where the positive electrode active material layer 15 overlaps the negative electrode current collector 11′ in plan view on the main surface where the solid electrolyte layer 17 faces the negative electrode active material layer 13. The ion-conductive reaction suppression layer 18 can conduct lithium ions. In addition, the ion-conductive reaction suppression layer 18 also has a function of suppressing a reaction between lithium metal (negative electrode active material layer 13) deposited on the negative electrode current collector 11′ during charging and the solid electrolyte contained in the solid electrolyte layer 17.

In the lithium secondary battery of the present aspect, as illustrated in FIG. 2(a), a layer 31 containing copper sulfide is disposed between the ion-conductive reaction suppression layer 18 and the negative electrode current collector 11′ containing copper during complete discharge. Along with charging, lithium metal is deposited between the ion-conductive reaction suppression layer 18 and the layer 31 containing copper sulfide to form the negative electrode active material layer 13 of FIG. 2(b).

Conventionally, in a lithium secondary battery using a sulfur-containing component and using a negative electrode current collector containing copper, sulfurization of the current collector leads to an increase in internal resistance and deterioration of the battery due to a decrease in ductility and malleability of the negative electrode current collector, and thus has been considered to be preferably suppressed as much as possible. However, in the lithium deposition type battery, as illustrated in FIG. 2(a), the ion-conductive reaction suppression layer 18 may be provided on the negative electrode current collector 11′. At this time, it has been found that, if the adhesion between the negative electrode current collector 11′ and the ion-conductive reaction suppression layer 18 is too high, lithium metal may be deposited not only at the interface between the negative electrode current collector 11′ and the ion-conductive reaction suppression layer 18 but also between the ion-conductive reaction suppression layer 18 and the solid electrolyte layer 17 during charging. As a result, a short circuit of the battery may occur due to dendrite growth of the deposited lithium metal.

By contrast, in the lithium secondary battery of the present aspect, a layer 31 containing copper sulfide is disposed between the ion-conductive reaction suppression layer 18 and the negative electrode current collector 11′ during complete discharge. Since copper sulfide does not have ductility or malleability of metal and is brittle, the adhesion between the ion-conductive reaction suppression layer 18 and the negative electrode current collector 11′ is lowered by this configuration. Consequently, lithium metal is selectively deposited between the ion-conductive reaction suppression layer 18 and the layer 31 containing copper sulfide during charging. As a result, the deposited lithium metal is not in contact with the solid electrolyte layer 17, so that a short circuit of the battery can be suppressed. At this time, by controlling the thickness of the layer 31 containing copper sulfide within a predetermined range, an increase in the internal resistance of the battery can be controlled within an allowable range. Furthermore, since the effect of electrolytic corrosion prevention of the negative electrode current collector is obtained by charging, it is possible to suppress excessive growth of the layer containing copper sulfide. Therefore, a battery having excellent battery performance may be obtained. In addition, it is easy to use a current collector containing copper, which has been conventionally difficult to apply in a system using a positive electrode active material containing a sulfur element or a sulfide solid electrolyte because of high reactivity with sulfur. Consequently, it is possible to broaden the application range of the current collector material in the lithium secondary battery, which is also advantageous in production equipment and cost.

The layer containing copper sulfide may be formed on at least a part of the interface between the negative electrode current collector and the ion-conductive reaction suppression layer, but may be formed on the entire interface between the negative electrode current collector and the ion-conductive reaction suppression layer.

The layer containing copper sulfide is not particularly limited, but may be substantially made of copper sulfide (Cu₂S or CuS). The layer containing copper sulfide may be, for example, a layer formed by sulfurization of copper contained in the current collector as described later. The phrase “substantially made of copper sulfide” means that mixing of impurities of about 2 to 3% by mass or less may be permitted.

The thickness of the layer containing copper sulfide is 100 nm or less. When the thickness of the layer containing copper sulfide exceeds 100 nm, the internal resistance increases, and the performance of the battery may deteriorate. The thickness of the layer containing copper sulfide may be 90 nm or less, 80 nm or less, or 50 nm or less from the viewpoint of achieving prevention of short circuit and improvement of battery performance in a well-balanced manner. The lower limit value of the thickness of the layer containing copper sulfide is not particularly limited, but may be, for example, more than 0, 1 nm or more, or 10 nm or more. Within the above-described range, the effect of one or more embodiments of the present invention may be more remarkably obtained.

The presence of the layer containing copper sulfide can be confirmed by observing a cross section in the lamination direction of the battery using a scanning electron microscope (SEM), an energy dispersive X-ray analyzer (EDX), and an X-ray photoelectron spectrometer (XPS).

For the thickness of the layer containing copper sulfide, in the image of the cross section measured as described above, in the region where the negative electrode current collector and the ion-conductive reaction suppression layer are in contact with each other, 3 points×the number of stacked layers per single battery layer are measured at each of the central part and the end part in the plane direction, and the average value thereof is determined. For example, when the negative electrode active material layer has a rectangular shape, among positions obtained by dividing a diagonal line (broken line with one dot) in a plane illustrated in FIG. 2(c) into six equal parts (positions denoted with a numeral of 1 to 5 in FIG. 2(c)), a position denoted with a numeral of 1 or 5 or the vicinity thereof can be defined as an end part. Furthermore, a position denoted with a numeral of 3 or the vicinity thereof can be set as the central part.

In the present specification, the phrase “the thickness of the layer containing copper sulfide is 100 nm or less” means that both the average value of the thickness at the central part and the average value of the thickness at the end part are 100 nm or less. In addition, the phrase “the thickness of the layer containing copper sulfide is 1 nm or more” means that both the average value of the thickness at the central part and the average value of the thickness at the end part are 1 nm or more.

In the lithium secondary battery of the present aspect, a method for introducing a layer containing copper sulfide is not particularly limited. For example, a method may be used including a step of producing a battery precursor in which a negative electrode current collector containing copper, an ion-conductive reaction suppression layer, a solid electrolyte layer, a positive electrode active material layer, and a positive electrode current collector are laminated in this order; and a step of holding the battery precursor at a temperature of 20° C. or higher for more than 24 hours to form a layer containing copper sulfide having a thickness of 100 nm or less between the negative electrode current collector and the ion-conductive reaction suppression layer.

By holding the battery precursor at a temperature of 20° C. or higher for more than 24 hours, sulfur contained in the solid electrolyte layer or the positive electrode active material layer passes through the ion-conductive reaction suppression layer and is transmitted to the surface of the negative electrode current collector containing copper. Then, copper sulfide may be deposited by reacting with copper contained in the negative electrode current collector at the interface with the negative electrode current collector.

That is, according to one or more aspects of the present invention, a method for manufacturing a lithium secondary battery is provided, the lithium secondary battery including a power generating element including: a positive electrode in which a positive electrode active material layer containing a positive electrode active material capable of occluding and releasing lithium ions is disposed on a surface of a positive electrode current collector; a negative electrode including a negative electrode current collector containing copper and in which lithium metal is deposited on the negative electrode current collector during charging; and a solid electrolyte layer that is interposed between the positive electrode and the negative electrode and contains a solid electrolyte, in which the positive electrode active material contains a sulfur element, or the solid electrolyte layer contains a sulfide solid electrolyte, and an ion-conductive reaction suppression layer having lithium-ion conductivity and suppressing a reaction between the lithium metal and the solid electrolyte is provided on a surface of the solid electrolyte layer on the negative electrode current collector side, the method for manufacturing including a step of producing a battery precursor in which the negative electrode current collector, the ion-conductive reaction suppression layer, the solid electrolyte layer, the positive electrode active material layer, and the positive electrode current collector are laminated in this order, and a step of holding the battery precursor at a temperature of 20° C. or higher for more than 24 hours to form a layer containing copper sulfide having a thickness of 100 nm or less between the negative electrode current collector and the ion-conductive reaction suppression layer.

The specific procedure for producing the above-described battery precursor is not particularly limited, and conventionally known methods may be appropriately referred to.

The specific procedure for forming the above-described layer containing copper sulfide is not particularly limited as long as the battery precursor can be held at a predetermined temperature for a predetermined time. At this time, the thickness of the layer containing copper sulfide can be controlled to be 100 nm or less by appropriately adjusting the temperature and time for holding the battery precursor, and the amount of the sulfide solid electrolyte serving as a sulfur source or the positive electrode active material containing sulfur. The temperature for holding the battery precursor can be appropriately set according to the holding time, the desired thickness of the layer containing copper sulfide, the amount of the sulfide solid electrolyte serving as a sulfur source or the positive electrode active material containing sulfur, and the like. In one embodiment, the battery precursor may be held at a temperature of 25° C. or higher for more than 24 hours. The upper limit value of the temperature may be, for example, 120° C. or lower, or 100° C. or lower. The holding time only needs to be longer than 24 hours until the battery precursor obtained is charged, assuming that a time when the negative electrode current collector containing copper, the ion-conductive reaction suppression layer, the solid electrolyte layer, the positive electrode active material layer, and the positive electrode current collector are brought into contact with each other is 0 hour in the step of producing the above-described battery precursor. For example, the holding time can be a time from when a battery precursor is obtained by bringing a copper-containing negative electrode current collector, an ion-conductive reaction suppression layer, a solid electrolyte layer, a positive electrode active material layer, and a positive electrode current collector into contact with each other to when charging of the battery precursor is started. The holding time depends on the desired thickness and temperature of the layer containing copper sulfide, and may be, for example, 36 hours or more, two days or more, or three days or more. The upper limit value of the holding time may be, for example, 10 days or less, or seven days or less.

The step of forming the layer containing copper sulfide may be performed in a state where the above-described battery precursor is pressurized using, for example, a pressurizing member described later. The pressurization conditions are also not particularly limited, and for example, conditions similar to those described later may be adopted.

In one aspect, after the holding is performed, a step of charging the obtained battery may be performed. Consequently, it is possible to stop sulfurization of copper and to cause lithium metal to be deposited between the ion-conductive reaction suppression layer and the layer containing copper sulfide. The condition for charging may be any condition as long as the negative electrode active material layer is formed of the deposited lithium metal, and may be appropriately set.

According to the method of the present aspect, in a lithium deposition type battery, lithium metal can be selectively deposited between the ion-conductive reaction suppression layer and the negative electrode current collector by a simple method. As a result, it is possible to prevent a short circuit of the battery while maintaining high battery performance. In addition, it is not necessary to change the battery design (for example, redesign of other components such as a negative electrode current collector containing copper, an ion-conductive reaction suppression layer, a solid electrolyte layer, a positive electrode active material layer, and a positive electrode current collector, and the like) accompanying the introduction of the layer containing copper sulfide. Therefore, a high-performance battery may be more easily obtained. In addition, there is an advantage that contamination of impurities and side reactions associated with introduction of a layer containing copper sulfide can be suppressed.

FIG. 3 is a perspective view of a laminate type secondary battery according to one or more embodiments of the present invention. As illustrated in FIG. 3, the laminate type secondary battery 100 according to the present embodiment includes the power generating element 21 sealed in the laminate film 29 illustrated in FIG. 1, two metal plates 200 sandwiching the power generating element 21 sealed in the laminate film 29, and a bolt 300 and a nut 400 as fastening members. The fastening members (the bolt 300 and the nut 400) have a function of fixing the power generating element 21 sealed in the laminate film 29 in a state where the metal plate 200 sandwiches the power generating element 21. Consequently, the metal plate 200 and the fastening member function as a pressurizing member configured to pressurize (confine) the power generating element 21 in the lamination direction thereof. Note that the pressurizing member is not particularly limited as long as the pressurizing member can pressurize the power generating element 21 in the lamination direction thereof. Typically, a combination of a plate formed of a material having rigidity such as the metal plate 200 and the above-described fastening member is used as the pressurizing member. In addition, as the fastening member, not only the bolt 300 and the nut 400 but also a tension plate that fixes the end part of the metal plate 200 so as to confine the power generating element 21 in the lamination direction, or the like may be used.

Note that the lower limit of the load applied to the power generating element 21 (confining pressure in the lamination direction of the power generating elements) may be, for example, 0.1 MPa or more, 1 MPa or more, 3 MPa or more, or 5 MPa or more. The upper limit of the confining pressure applied to the power generating element in the lamination direction of the power generating elements may be, for example, 100 MPa or less, 70 MPa or less, 40 MPa or less, or 10 MPa or less.

Hereinafter, main components of the laminate type secondary battery 10a described above will be described.

### Positive Electrode Current Collector

The positive electrode current collector is an electric conductive member configured to function as a flow path for electrons emitted from the positive electrode toward the power source with the progress of a battery reaction (charge-discharge reaction) or flowing from an external load toward the positive electrode. As a constituent material of the positive electrode current collector, for example, a metal or a resin having electric conductivity may be adopted. The thickness of the positive electrode current collector is not particularly limited, and is, for example, 10 to 100 μm.

### Positive Electrode Active Material Layer

A positive electrode constituting the lithium secondary battery according to the present aspect has a positive electrode active material layer containing a positive electrode active material capable of occluding and releasing lithium ions. The positive electrode active material layer 15 is disposed on the surface of the positive electrode current collector 11″ as illustrated in FIG. 1.

The positive electrode active material is not particularly limited as long as it is a material capable of releasing lithium ions in the charging process of the secondary battery and occluding lithium ions in the discharging process. An example of such a positive electrode active material includes a material containing M1 element and O element, the M1 element containing at least one kind of element selected from the group consisting of Li, Mn, Ni, Co, Cr, Fe, and P. Examples of such a positive electrode active material include layered rock salt type active materials such as LiCoO₂, LiMnO₂, LiNiO₂ and Li (Ni—Mn—Co) O₂, spinel-type active materials such as LiMn₂O₄ and LiNi_{0.5}Mn_{1.5}O₄, olivine type active materials such as LiFePO₄ and LiMnPO₄, Si-containing active materials such as Li₂FeSiO₄ and Li₂MnSiO₄, and the like. Examples of the oxide active material other than those described above include Li₄Ti₅O₁₂ and LiVO₂.

The positive electrode active material may be any material containing a sulfur element. The positive electrode active material containing a sulfur element is not particularly limited, but examples thereof include particles or thin films of an organic sulfur compound or an inorganic sulfur compound in addition to the sulfur simple substance (S), and may be any material as long as the material can release lithium ions during charging and occlude lithium ions during discharging by utilizing the oxidation-reduction reaction of sulfur. Examples of the organic sulfur compound include disulfide compounds, sulfur-modified polyacrylonitrile, sulfur-modified polyisoprene, rubeanic acid (dithiooxamide), polysulfide carbon, and the like.

On the other hand, examples of the inorganic sulfur compound include sulfur simple substance (S), Li₂S, S-carbon composite, TiS₂, TiS₃, TiS₄, NiS, NiS₂, CuS, FeS₂, MoS₂, MoS₃, and the like. Note that as the sulfur simple substance (S), α sulfur, β sulfur, or γ sulfur having an S₈ structure may be used. These sulfur simple substances (S) occlude lithium ions during discharge and exist in the positive electrode active material layer in the form of a (multiple) sulfide of lithium. In addition, the positive electrode active material containing sulfur element serves as a sulfur source containing copper sulfide.

In some cases, two or more kinds of positive electrode active materials may be used in combination. It is needless to say that a positive electrode active material other than the above may be used. The content of the positive electrode active material in the positive electrode active material layer is not particularly limited, but may be 30 to 99% by mass, 40 to 90% by mass, or 45 to 80% by mass.

In one aspect, the positive electrode active material layer 15 may further contain a solid electrolyte. Examples of the solid electrolyte include a sulfide solid electrolyte and an oxide solid electrolyte.

From the viewpoint of exhibiting excellent lithium-ion conductivity and being capable of better following the volume change of the electrode active material accompanying charge and discharge, the solid electrolyte may be a sulfide solid electrolyte containing a S element, a sulfide solid electrolyte containing a Li element, an M element, and a S element, the M element containing at least one kind of element selected from the group consisting of P, Si, Ge, Sn, Ti, Zr, Nb, Al, Sb, Br, Cl, and I, or a sulfide solid electrolyte containing a S element, a Li element, and a P element.

The sulfide solid electrolyte may have a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr——Li₃PS₄, and Li₃PS₄. In addition, examples of the sulfide solid electrolyte having a Li₄P₂S₇ skeleton include a Li—P—S-based solid electrolyte called LPS. In addition, as the sulfide solid electrolyte, for example, LGPS represented by Li₍₄₋ₓ₎Ge₍₁₋ₓ₎PₓS₄ (x satisfies 0<x<1) or the like may be used. More specifically, for example, LPS (Li₂S—P₂S₅), Li—P₃S₁₁, Li_{3.2}P_{0.96}S, Li_{3.25}Ge_{0.25}P_{0.75}S₄, Li₁₀GeP₂S₁₂, or Li₆PS₅X (wherein X is Cl, Br or I) or the like can be included. Note that the description of “Li₂S—P₂S₅” means a sulfide solid electrolyte obtained using a raw material composition containing Li₂S and P₂S₅, and the same applies to other descriptions. Among them, from the viewpoint of having a high ion conductivity and a low volume elastic modulus and thus being capable of better following the change in volume of the electrode active material accompanying charge and discharge, the sulfide solid electrolyte may be selected from the group consisting of LPS (Li₂S—P₂S₅), Li₆PS₅X (wherein X is Cl, Br or I), Li₇P₃S₁₁, Li_{3.2}P_{0.96}S, and Li₃PS₄.

The content of the solid electrolyte in the positive electrode active material layer is not particularly limited, but may be 1 to 70% by mass, 10 to 60% by mass, or 20 to 55% by mass.

The positive electrode active material layer may further contain at least one of a conductive aid and a binder in addition to the positive electrode active material and the solid electrolyte. The thickness of the positive electrode active material layer may be 0.1 to 1000 μm, or 40 to 100 μm.

### Solid Electrolyte Layer

The solid electrolyte layer contains a solid electrolyte. Since the specific form of the solid electrolyte contained in the solid electrolyte layer is the same as that described above, the detailed description thereof is omitted here.

In one aspect, the solid electrolyte layer further contains a sulfide solid electrolyte. The sulfide solid electrolyte has excellent lithium-ion conductivity, and is excellent in heat resistance and stability under high voltage. In addition, the sulfide solid electrolyte serves as a sulfur source of a layer containing copper sulfide. Note that in the lithium secondary battery of the present aspect, the sulfur source of the layer containing copper sulfide may be the positive electrode active material containing the sulfur element in the positive electrode active material layer as described above, or may be the sulfide solid electrolyte in the solid electrolyte layer. However, for a reason that a layer containing copper sulfide having a predetermined thickness can be formed more efficiently and the effect of one or more embodiments of the present invention may be obtained more remarkably, the sulfide solid electrolyte in the solid electrolyte layer may be preferable.

The content of the solid electrolyte in the solid electrolyte layer may be 10 to 100% by mass, 50 to 100% by mass, or 90 to 100% by mass. The solid electrolyte layer may further contain a binder in addition to the solid electrolyte. The thickness of the solid electrolyte layer may be 0.1 to 1000 μm, or 10 to 40 μm. Note that when a sulfide solid electrolyte is used as the solid electrolyte, it may be preferable to control the thickness of the solid electrolyte layer in the range of 10 to 40 μm because the thickness of the layer containing copper sulfide can be more easily controlled to 100 nm or less.

### Negative Electrode Current Collector

The negative electrode current collector is an electric conductive member configured to function as a flow path for electrons emitted from the negative electrode toward the external load with the progress of a battery reaction (charge-discharge reaction) or flowing from a power source toward the negative electrode. In the lithium secondary battery according to the present aspect, the negative electrode current collector essentially contains copper. The negative electrode current collector may include only a copper simple substance, or may include an alloy of copper and another metal. Furthermore, the negative electrode current collector may include a material made by adding a conductive filler containing copper to a non-conductive polymer. The thickness of the negative electrode current collector is not particularly limited, and is, for example, 10 to 100 μm.

### Negative Electrode Active Material Layer

The lithium secondary battery according to the present aspect is a so-called lithium deposition type battery in which lithium metal is deposited on a negative electrode current collector in a charging process. A layer made of lithium metal deposited on the negative electrode current collector in this charging process is the negative electrode active material layer of the lithium secondary battery according to the present aspect. Therefore, the thickness of the layer of lithium metal deposited increases with the progress of the charging process, and the thickness of the layer of lithium metal decreases as the discharging process proceeds. There may be no layer of lithium metal during complete discharge, but in some cases, a layer of lithium metal may be disposed during complete discharge. In addition, the thickness of the layer of the lithium metal during complete charge is not particularly limited, but is usually 0.1 to 1000 μm.

### Ion-Conductive Reaction Suppression Layer

In the lithium secondary battery according to the present aspect, an ion-conductive reaction suppression layer is provided on the surface of the solid electrolyte layer on the negative electrode current collector side. The ion-conductive reaction suppression layer is a layer having lithium-ion conductivity and suppressing the reaction between the deposited lithium metal and the solid electrolyte. By providing the ion-conductive reaction suppression layer, it is possible to prevent deterioration of the solid electrolyte caused by the reaction between the deposited lithium metal and the solid electrolyte and a decrease in battery capacity without hindering the progress of the battery reaction.

Here, the phrase that a material “has lithium-ion conductivity” means that the degree of lithium-ion conductivity of the material at 25° C. is 1×10^{-4 [}S/cm] or more. On the other hand, the phrase that a material “does not have degree of lithium-ion conductivity” means that the lithium-ion conductivity of the material at 25° C. is less than 1×10^{-4 [}S/cm].

In the lithium secondary battery according to the present aspect, the degree of lithium-ion conductivity of the constituent material of the ion-conductive reaction suppression layer at 25° C. may be 1×10^{-4 [}S/cm] or more, 1.5×10^{-4 [}S/cm] or more, 2.0× 10^{-4 [}S/cm] or more, 2.5×10^{-4 [}S/cm] or more, or 3.0×10^{-4 [}S/cm] or more.

The constituent material of the ion-conductive reaction suppression layer is not particularly limited, and various materials capable of expressing the function described above can be employed. Examples of the constituent material of the ion-conductive reaction suppression layer include nanoparticles having lithium-ion conductivity. Here, the word “nanoparticles” means particles having an average particle diameter on a scale of nanometers (nm). The “average particle diameter” of nanoparticles refers to a 50% cumulative diameter (D50) with respect to a particle diameter (maximum distance among distances between any two points on the outline of the observed particle) measured by observing a cross section of a layer containing nanoparticles with a scanning electron microscope (SEM). The average particle diameter of the nanoparticles may be 500 nm or less, 300 nm or less, or 150 nm or less. Note that the lower limit value of the average particle diameter of the nanoparticles is not particularly limited, but may be 10 nm or more, or 20 nm or more.

From the viewpoint of being particularly excellent in the function as the ion-conductive reaction suppression layer, such nanoparticles may contain, for example, one or two or more kinds of elements selected from the group consisting of carbon, gold, platinum, palladium, silicon, silver, aluminum, bismuth, tin, iron, and zinc, or may contain one or two or more kinds of a simple substance or an alloy of these elements. In addition, the nanoparticle may contain carbon, or may be made of a simple substance of carbon. Examples of the material made of a simple substance of carbon include acetylene black, Vulcan (registered trademark), Black Pearl (registered trademark), carbon nanofiber, Ketjen Black (registered trademark), carbon nanotube, carbon nanohorn, carbon nanoballoon, fullerene, and the like. Note that when the ion-conductive reaction suppression layer contains such nanoparticles, the layer may further contain a binder.

The ion-conductive reaction suppression layer may contain a material capable of forming a sulfur and compound. Consequently, the conductivity of sulfur is improved, and the effect of one or more embodiments of the present invention may be more remarkably obtained. Examples of such a material include metal materials such as gold, platinum, palladium, silicon, silver, copper, aluminum, bismuth, tin, iron, and zinc. The ion-conductive reaction suppression layer may be used by combining a material made of a simple substance of carbon excellent in lithium-ion conductivity and electric conductivity and a metal material excellent in sulfur conductivity. At this time, the mixing ratio of the metal material and the material made of a simple substance of carbon is not particularly limited, but the mass ratio of the metal material:the material made of a simple substance of carbon may be 45:55 to 5:95, or 40:60 to 10:90.

A technique for forming the ion-conductive reaction suppression layer containing nanoparticles on the surface of the solid electrolyte layer on the negative electrode current collector side is not particularly limited, but for example, a technique may be adopted that applies a slurry in which the nanoparticles and a binder as necessary are dispersed in an appropriate solvent to the surface of the solid electrolyte layer on the negative electrode current collector side, and dries the solvent. In some cases, a continuous layer containing any of the materials described above may be formed by a technique such as sputtering instead of the form of nanoparticles to provide the ion-conductive reaction suppression layer.

Although the nanoparticles for the constituent material of the ion-conductive reaction suppression layer have been described above, the ion-conductive reaction suppression layer may include other constituent materials. Examples of other constituent materials include one or two or more kinds of lithium-containing compounds selected from the group consisting of lithium halide (LiF, LiCl, LiBr, LiI), a composite metal oxide represented by Li-M-O (M is one or two or more kinds of metal elements selected from the group consisting of Mg, Au, Al, Sn, and Zn), and a Li—Ba—TiO₃ composite oxide. All of these materials are more stable than the solid electrolyte in reductive decomposition due to contact with lithium metal, and thus may function as an ion-conductive reaction suppression layer. The technique for forming the ion-conductive reaction suppression layer containing the lithium-containing compound is also not particularly limited, but for example, a continuous layer containing the lithium-containing compound can be formed by a method such as sputtering to form the ion-conductive reaction suppression layer.

Note that the ion-conductive reaction suppression layer may not contain a solid electrolyte. When the solid electrolyte is not contained, the deposited lithium metal can be prevented from penetrating to the solid electrolyte layer side through the ion-conductive reaction suppression layer. As a result, the effect of preventing a short circuit of the lithium secondary battery may be more remarkably obtained. In an embodiment, the content of the solid electrolyte in the ion-conductive reaction suppression layer may be, for example, 1% by mass or less, 0.5% by mass or less, or 0.1% by mass or less in terms of solid content.

The average thickness of the ion-conductive reaction suppression layer is not particularly limited, and the ion-conductive reaction suppression layer only needs to be disposed with a thickness capable of exhibiting the function described above. However, from the viewpoint of suppressing a decrease in charge-discharge efficiency due to an increase in internal resistance of the battery, the average thickness of the ion-conductive reaction suppression layer may be smaller than the average thickness of the solid electrolyte layer. In addition, from the viewpoint of sufficiently obtaining the effect by providing the ion-conductive reaction suppression layer, the average thickness of the ion-conductive reaction suppression layer may be 300 nm to 20 μm, 500 nm to 15 μm, or 1 to 10 μm when the layer is a layer containing nanoparticles. When the layer is a continuous layer formed by a technique such as sputtering, the thickness may be 0.5 to 20 nm. Note that the “average thickness” of the ion-conductive reaction suppression layer means a value calculated as an arithmetic average value of the thicknesses measured at several to several tens of different portions of the ion-conductive reaction suppression layer constituting the lithium secondary battery.

### Layer Containing Copper Sulfide

Since the specific form of the layer containing copper sulfide is as described above, the detailed description thereof is omitted.

In the lithium secondary battery of the present aspect, the peel strength between the ion-conductive reaction suppression layer and the negative electrode current collector may be 0.05 N/mm or less. With this configuration, the effect of preventing a short circuit may be more remarkably obtained. The peel strength may be 0.03 N/mm or less, or 0.02 N/mm or less. In addition, the lower limit value of the peel strength is not particularly limited, but when the peel strength is 0.011 N/mm or more, the internal resistance of the battery is not excessively high, so that good battery performance may be obtained. The peel strength can be adjusted by adjusting the thickness of the layer containing copper sulfide. Note that the peel strength can be measured by the method described in Examples.

Note that the following embodiments are also included in the scope of the present invention: the lithium secondary battery according to claim 1 having the features of claim 2; the lithium secondary battery according to claim 1 or 2, the lithium secondary battery having the feature of claim 3; the lithium secondary battery according to any one of claims 1 to 3, the lithium secondary battery having the feature of claim 4; the lithium secondary battery according to any one of claims 1 to 4, the lithium secondary battery having the feature of claim 5.

### EXAMPLES

Hereinafter, one or more embodiments of the present invention will be described in more detail with reference to Examples. However, the technical scope of the present invention is not limited only to Examples described below. Note that the operation described below was performed in a glove box. Instruments, devices, and the like used in the glove box were sufficiently dried in advance.

### Example 1

### Production of Evaluation Cell

First, LiNi_{0.8}Mn_{0.1}Co_{0.1}O₂ as a positive electrode active material, polytetrafluoroethylene (PTFE) as a binder, and a sulfide solid electrolyte (LPS(Li₂S—P₂S₅)) were weighed so that a mass ratio of them is 70:5:25, and mixed in a glove box using an agate mortar. Mesitylene was added as a solvent to the obtained mixed powder to prepare a positive electrode active material slurry. Next, the positive electrode active material slurry prepared above was applied onto the surface of a stainless steel (SUS) foil as a positive electrode current collector and dried to form a positive electrode active material layer (thickness: 50 μm), thereby producing a positive electrode.

To 100 parts by mass of a sulfide solid electrolyte (LPS (Li₂S—P₂S₅)), 2 parts by mass of styrene-butadiene rubber (SBR) was added, and mesitylene as a solvent was added to prepare a solid electrolyte slurry. Next, the solid electrolyte slurry prepared above was applied onto the surface of a stainless steel foil as a support and dried to produce a solid electrolyte layer (thickness: 25 μm) on the surface of the stainless foil. Next, the positive electrode active material layer of the positive electrode produced as described above and the solid electrolyte layer similarly produced as described above were superimposed so as to face each other. Thereafter, they were bonded to each other by isostatic pressing, and the stainless steel foil on the solid electrolyte layer side was peeled off to obtain a laminate of positive electrode current collector/positive electrode active material layer/solid electrolyte layer.

On the other hand, silver nanoparticles and carbon black nanoparticles were prepared as constituent materials of the ion-conductive reaction suppression layer. To 100 parts by mass of the total amount of the silver nanoparticles and the carbon black nanoparticles (25 parts by mass of the silver nanoparticles and 75 parts by mass of the carbon black nanoparticles), 10 parts by mass of SBR were added, and mesitylene as a solvent was added to prepare a nanoparticle slurry. Next, the nanoparticle slurry prepared above was applied to the surface of the copper foil (thickness: 10 μm; also functions as a negative electrode current collector), and dried to produce an ion-conductive reaction suppression layer (thickness: 10 μm) on the surface of the copper foil as a support. In addition, the average particle diameter (D50) of the carbon black nanoparticles contained in the ion-conductive reaction suppression layer thus produced was measured by SEM observation of a cross section of the ion-conductive reaction suppression layer, and found to be 150 nm. In addition, the average particle diameter (D50) of the silver nanoparticles was measured in the same manner and found to be 150 nm.

Next, the ion-conductive reaction suppression layer produced as described above was superimposed on the central part of the exposed surface of the solid electrolyte layer in the laminate of positive electrode current collector/positive electrode active material layer/solid electrolyte layer produced as described above, and then bonded by isostatic pressing. Next, a positive electrode lead and a negative electrode lead were connected to the positive electrode current collector and the negative electrode current collector, respectively. This was held inside a thermostatic bath at 25° C. for three days to obtain an evaluation cell of this Example.

### Example 2

An evaluation cell of Example 2 was obtained in the same manner as in Example 1 except that the step of holding inside the thermostatic bath at 25° C. for three days was changed to the step of holding inside a thermostatic bath at 60° C. for three days.

### Example 3

In Example 1, the thickness of the solid electrolyte layer was changed from 25 μm to 28 μm. In addition, the step of holding inside the thermostatic bath at 25° C. for three days was changed to the step of holding inside a thermostatic bath at 100° C. for seven days. Except for these, an evaluation cell of Example 3 was obtained in the same manner as in Example 1.

### Comparative Example 1

An evaluation cell of Comparative Example 1 was obtained in the same manner as in Example 1 except that the step of holding inside the thermostatic bath at 25° C. for three days was not performed.

### Comparative Example 2

The thickness of the solid electrolyte layer produced on the surface of the stainless steel foil in Example 3 was changed to 30 μm, and 12 sheets of the solid electrolyte layer were produced. Then, a step of bonding a solid electrolyte layer onto the positive electrode active material layer on the positive electrode current collector and peeling off the stainless steel foil on the solid electrolyte layer side was sequentially performed to obtain a laminate in which 12 solid electrolyte layers were laminated (the thickness of the solid electrolyte layer was 360 μm). Except for these, an evaluation cell of comparative Example 2 was obtained in the same manner as in Example 3.

### Confirmation of Generation of Layer Containing Copper Sulfide

A cross section in the lamination direction of the evaluation cell produced as described above was observed using a scanning electron microscope (SEM), an energy dispersive X-ray analyzer (EDX), and an X-ray photoelectron spectrometer (XPS). As a result, in the cells of Examples 1 to 3 and Comparative Example 2, it was confirmed that a copper sulfide layer was formed over the entire interface between the negative electrode current collector and the ion-conductive reaction suppression layer. The thickness of this copper sulfide layer was determined and illustrated in Table 1 below. Note that in the cell of Comparative Example 1, a layer of copper sulfide was not observed.

### Evaluation Example of Test Cell

### Evaluation of Adhesion at Interface Between Ion-Conductive Reaction Suppression Layer and Negative Electrode Current Collector

Using a laminate of positive electrode current collector/positive electrode active material layer/solid electrolyte layer/ion-conductive reaction suppression layer/negative electrode current collector produced in the same manner as in the production example of the test cell described above, the surface on the positive electrode current collector side was fixed to a table using a double-sided tape. Next, the negative electrode current collector was peeled off at a peeling rate of 50 mm/min to perform a 90° peeling test. Consequently, the peel strength when the ion-conductive reaction suppression layer and the negative electrode current collector were peeled off was measured.

### Evaluation of Cycle Durability and Confirmation of Presence or Absence of Short Circuit

The discharge capacity retention rate after five cycles was measured under the temperature condition of 25° C. for the evaluation cell produced above. Specifically, using a charge-discharge tester, in a charging process (lithium metal is deposited on the negative electrode current collector), a constant current and constant voltage (CCCV) mode was set, and charging was performed from 2.5 V to 4.3 V (0.01 C cut-off). After pausing 10 minutes, in the discharging process (lithium metal on the negative electrode current collector was dissolved), a constant current (CC) mode was set, and discharging was performed from 4.3 V to 2.5 V. At this time, the first charge-discharge was performed at 0.1 C, and the subsequent charge-discharge cycle was performed at 0.5 C. Then, a total of five cycles of this cycle were performed (ten minutes of pause time was also provided between the cycles).

The discharge capacity retention rate was calculated as a percentage of the discharge capacity at the fifth cycle to the discharge capacity at the first cycle. With respect to the presence or absence of a short circuit, it was determined that there was a short circuit when the voltage sharply dropped or when the voltage did not reach a predetermined upper limit voltage during charging, in the process of charging and discharging. The results are illustrated in Table 1 below. The case where there was a short circuit or the discharge capacity retention rate was less than 80% was evaluated as x, and the case where the discharge capacity retention rate was 80% or more without causing a short circuit was evaluated as ∘.

### Measurement of Internal Resistance

The capacity value (mAh/g) per mass of the positive electrode active material was calculated from the value of the charge and discharge capacity obtained after repeating the above charge and discharge cycle five times and the mass of the positive electrode active material contained in the positive electrode. Next, constant current discharge was performed at a current density of 0.2 mA/cm² up to a capacity of 50% (SOC 50%) with respect to the capacity value of 100% calculated in this way. After pausing 30 minutes, discharge was performed at a discharge rate of 1 C for 10 seconds, and a direct-current resistance value (DCR) was calculated according to Ohm's law from a voltage drop amount and a current value at that time, and taken as an internal resistance value of the test cell. The results are listed in Table 1 below. Note that the internal resistance value listed in Table 1 is a relative value when the value in Comparative Example 1 is 100.

TABLE 1

| | Solid | | Thickness | | | |
|---|---|---|---|---|---|---|
| | electrolyte | | of the layer | | Internal | Cycle |
| | layer | | containing | Peel | resistance | durability/ |
| | thickness | Temperature/ | copper sulfide | strength | (relative | short |
| | (μm) | holding time | (nm) | (N/mm) | value) | circuit |
| Example 1 | 25 | 25° C./three days | 10 | 0.0159 | 102 | ○ |
| Example 2 | 25 | 60° C./three days | 57 | 0.0141 | 110 | ○ |
| Example 3 | 28 | 100° C./seven days | 72 | 0.0144 | 111 | ○ |
| Comparative | 25 | 25° C./none | 0 | >0.15 | 100 | × |
| Example 1 | | | | | | |
| Comparative | 360 | 100° C./seven days | 1000 | 0.0102 | 281 | × |
| Example 2 | | | | | | |

From the results listed in Table 1, it has been found that according to one or more embodiments of the present invention, in a lithium deposition type lithium secondary battery using a sulfur-containing component and including a negative electrode current collector containing copper, a short circuit can be suppressed, and excellent battery performance can be achieved.

### REFERENCE SIGNS LIST

10a, 100 Laminate type secondary battery (lithium secondary battery)
11′ Negative electrode current collector
11″ Positive electrode current collector
13 Negative electrode active material layer
15 Positive electrode active material layer
17 Solid electrolyte layer
18 Ion-conductive reaction suppression layer
19 Single battery layer
21 Power generating element
25 Negative electrode current collecting plate (negative electrode tab)
27 Positive electrode current collecting plate (positive electrode tab)
29 Laminate film
31 Layer containing copper sulfide
200 Metal plate
300 Bolt
400 Nut

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A lithium secondary battery, comprising:
a positive electrode;
a negative electrode comprising a negative electrode current collector containing copper and a lithium metal anode when the lithium secondary battery is in at least partially charged state;
a solid electrolyte layer interposed between the positive electrode and the negative electrode;
an ion-conductive reaction suppression layer on a surface of the solid electrolyte layer and positioned in between the solid electrolyte layer and the negative electrode current collector having lithium-ion conductivity and suppressing a reaction between the lithium metal anode and the solid electrolyte layer; and
a layer containing copper sulfide having a thickness of 100 nm or less interposed between the negative electrode current collector and the ion-conductive reaction suppression layer or the lithium metal anode.

2. The lithium secondary battery according to claim 1, wherein the ion-conductive reaction suppression layer comprises one or more selected from the group consisting of carbon, gold, platinum, palladium, silicon, silver, aluminum, bismuth, tin, iron, and zinc.

3. The lithium secondary battery according to claim 1, wherein the ion-conductive reaction suppression layer has a lithium-ion conductivity of 1×10⁻⁴ [S/cm] or more.

4. The lithium secondary battery according to claim 1, wherein the ion-conductive reaction suppression layer has a thickness of 300 nm or more and 20 μm or less.

5. The lithium secondary battery according to claim 1, wherein the solid electrolyte layer comprises a sulfide solid electrolyte.

6. The lithium secondary battery according to claim 1, wherein the positive electrode comprises a positive electrode material comprising a sulfur element.

7. The lithium secondary battery according to claim 1, wherein the ion-conductive reaction suppression layer does not contain a solid electrolyte.

8. The lithium secondary battery according to claim 1, wherein the layer containing copper sulfide has a thickness of 10 nm or more.

9. The lithium secondary battery according to claim 1, wherein peel strength between the ion-conductive reaction suppression layer and the negative electrode current collector is 0.05 N/mm or less.

10. A method for producing a lithium secondary battery, the lithium secondary battery comprising:
a positive electrode comprising a positive electrode active material;
a negative electrode comprising a negative electrode current collector containing copper, and a lithium metal anode when the lithium secondary battery is in at least partially charged state;
a solid electrolyte layer interposed between the positive electrode and the negative electrode, wherein:
the positive electrode active material comprises a sulfur element, or the solid electrolyte layer comprises a sulfide solid electrolyte; and
an ion-conductive reaction suppression layer on a surface of the solid electrolyte layer and positioned in between the solid electrolyte layer and the negative electrode current collector having lithium-ion conductivity and suppressing a reaction between the lithium metal anode and the solid electrolyte layer, wherein
the method comprises:
holding an uncharged lithium secondary battery at a temperature of 20° C. or higher for more than 24 hours, thereby forming a layer containing copper sulfide having a thickness of 100 nm or less between the negative electrode current collector and the ion-conductive reaction suppression layer.

11. The method for producing the lithium secondary battery according to claim wherein the positive electrode active material comprises a sulfur element.

12. The method for producing the lithium secondary battery according to claim 10, wherein the solid electrolyte layer comprises a sulfide solid electrolyte.
